(19) United States
(12) Patent Application Publication
(10) Pub. No.: US 2005/0289350 A1
(43) Pub. Date: Dec. 29, 2005

(54) Method and system for secure synchronization between an enterprise system and a device

(76) Inventor: Markus Schmidt-Karaca, Heidelberg (DE)

Correspondence Address: KENYON & KENYON, 1500 K STREET NW, SUITE 700, WASHINGTON, DC, 20005, US

(21) Appl. No.: 10/877,844

(22) Filed: Jun. 25, 2004

(51) Int. Cl. H04L 9/00

(52) U.S. Cl. 713/176

(57) ABSTRACT

A method and system for secure synchronization between an enterprise system such as an ERP system and a mobile device. Before synchronization is allowed, a verified security parameter corresponding to a verified application is compared with a device security parameter representing an application running on the device

### FIELD OF THE INVENTION

The present invention relates to computer systems, information systems and computer software. In particular, the present invention provides a method and system for performing secure synchronization between a central server and a device such as a mobile device.

### BACKGROUND INFORMATION

In enterprise environments a central server often handles application deployment and administration. This scenario is desirable in order to insure security and allow for centralized control of software applications distributed throughout an organization. For example, ERP (“Enterprise Resource Planning”) systems are typically run on secure platforms where access to end-users is only possible via a GUI with appropriate access control. Security can be implemented in the source code. Restricting the physical access to administrators can prevent access to the source code (e.g., the hardware can be placed in a locked room).

The mobile environment presents special challenges for secure synchronization. Control is passed to software running on the mobile that is out of the control of the enterprise system. Extending the reach of ERP systems onto mobile devices introduces a new class of security risks because manipulation of the software on the device cannot be prevented. Any access control or authorization control inside the code is useless as long as the end user can manipulate the code and disable the security mechanisms. This is crucial for authorization checks where detailed decisions about which data may be manipulated strongly depends on the application logic. If multiple users share a mobile device it is not enough to authenticate both of them if they are meant to have different rights. Checking the rights at the ERP system is often not possible anymore because successive data changes cannot be resolved later.

Secure synchronization is often performed at the business level by checking the integrity of the data received at the enterprise system. Another approach is to perform secure synchronization by examining whether a person has rights to fulfill a process in a certain area. Another known mechanism to prevent the modification of code on a machine is to restrict administrative rights of users. However, this approach is not often attractive in a mobile environment, as it is not desirable to restrict administrative rights on a mobile device such as a PDA (“Personal Digital Assistant”).

In general, there exist no known methods for secure synchronization at the application level. That is, known methods do not allow performing authentication and synchronization as a function of the integrity of an application itself running on a device such as a mobile device.

Thus, there exists a need for a system and method for performing secure synchronization between an enterprise system and a device at the application level.

### SUMMARY OF THE INVENTION

The present invention provides a method and system for secure synchronization between an enterprise system such as an ERP system and a device such as a mobile device. The method and system operates at the application level. According to an embodiment of the present invention, before synchronization is allowed with a device, a middleware process performs authentication of the code stored on the requesting device by comparing a digital signature stored in the middleware with a digital signature of the code running on the mobile device. Upon authentication of the digital signature, synchronization is performed. If the authentication fails, synchronization is denied.

### BRIEF DESCRIPTION OF THE DRAWINGS

FIG. 1 is a block diagram of a system for performing secure synchronization between a central server and a mobile device according to one embodiment of the present invention.

FIG. 2 is a flowchart depicting a secure synchronization process according to one embodiment of the present invention.

FIG. 3 is a detailed block diagram of a system for performing secure synchronization between a central server and a mobile device according to one embodiment of the present invention.

### DETAILED DESCRIPTION

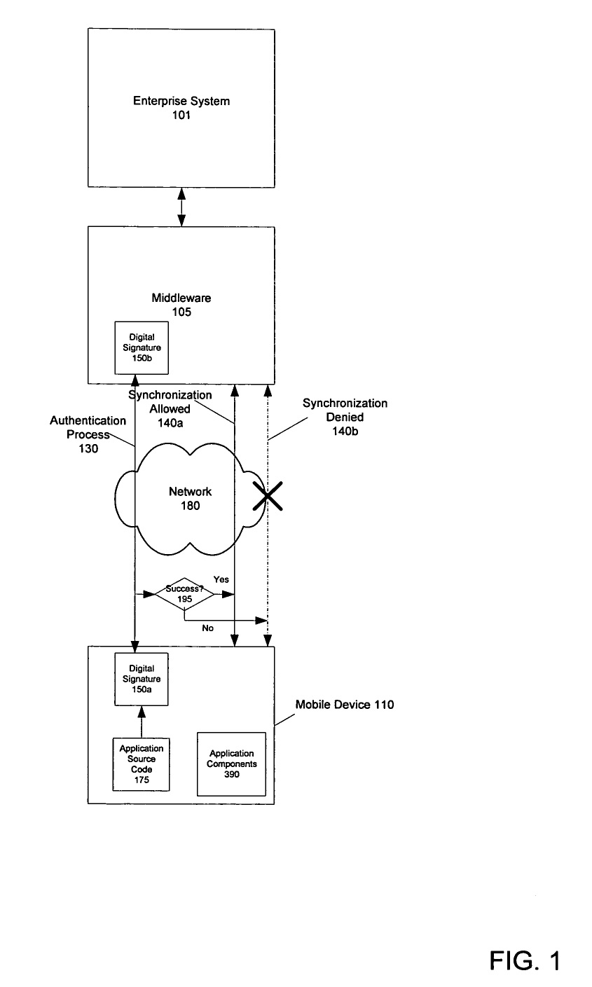

FIG. 1 is a block diagram of a system for performing secure synchronization between a central server and a device according to one embodiment of the present invention. According to one embodiment of the present invention, the device is a mobile device such as a PDA or laptop computer. However, the present invention may be applied to any type of devices mobile or fixed utilizing any type of network infrastructure. Referring to FIG. 1, mobile device 110 seeks synchronization with enterprise system 101. Synchronization may include data exchange between mobile device 110 and enterprise system 101 as well as deployment of application software from enterprise system 101 to mobile device 110.

According to one embodiment of the present invention, middleware 105 performs a process for secure synchronization between mobile device 110 and enterprise system 101. In authentication process 130, middleware 105 performs authentication with mobile device 110 by comparing a security parameter (for example, a digital signature) 150a corresponding to application components 390 running on mobile device with a security parameter (for example, a digital signature) 150b stored by middleware 105.

According to one embodiment, security parameter 150a is a digital signature which is generated as a function of an executable residing on the mobile device, application source code residing on the mobile device, and/or any resources necessary comprising the application that reside on the mobile device. For example, in the case of JIT (“Just In Time”) compilation, the security parameter may be generated from the source code itself residing on the device. In the case of a precompiled executable, the security parameter may be generated from the executable (e.g., binaries) residing on the mobile device. Thus, the security parameter (e.g., digital signature) 150a when generated, represents the integrity of the actual local running application components 390 on mobile device 390.

According to an embodiment, security parameter 150b is a digital signature stored by middleware 105, which is generated from a verified application source code (not shown). This example corresponds to a situation where the JIT compilation is employed and the source code for the application actually resides on the mobile device. However, it will be understood that the security parameter is generated from a binary executable and/or any other resources pertaining to an application running on the device. Therefore, the security parameter (e.g., digital signature) 150b is generated as a function of an application source code that should in fact be running mobile device 110. However, the device user or others may have tampered or altered application source code 175 on mobile device 110, re-compiled the application components 390, in which case a security breach exists.

Security parameters 150a and 150b may be digital signatures that are hash codes generated by a hash function (not shown). In the present example where the security parameters 150a and 150b are each digital signatures, digital signature 150a may be generated by a function, which receives application source code 175 as an input and generates a corresponding hash value. The method of generation of security parameters 150a and/or 150b is not important with respect to the present invention. It will be understood that any number of methods could be employed to generate digital signatures or other security parameters.

As noted above, application source code 175 may have been modified. In the present example, by comparing digital signatures 150a and 150b, synchronization and/or deployment of application components is allowed or disallowed. Only if authentication process 130 is successful (i.e., digital signature 150a matches digital signature 150b ), middleware 105 then performs synchronization process 140a. If in the present example the digital signatures 150a and 150b do not match, the authentication process 130 fails and middleware 105 denies synchronization 140b.

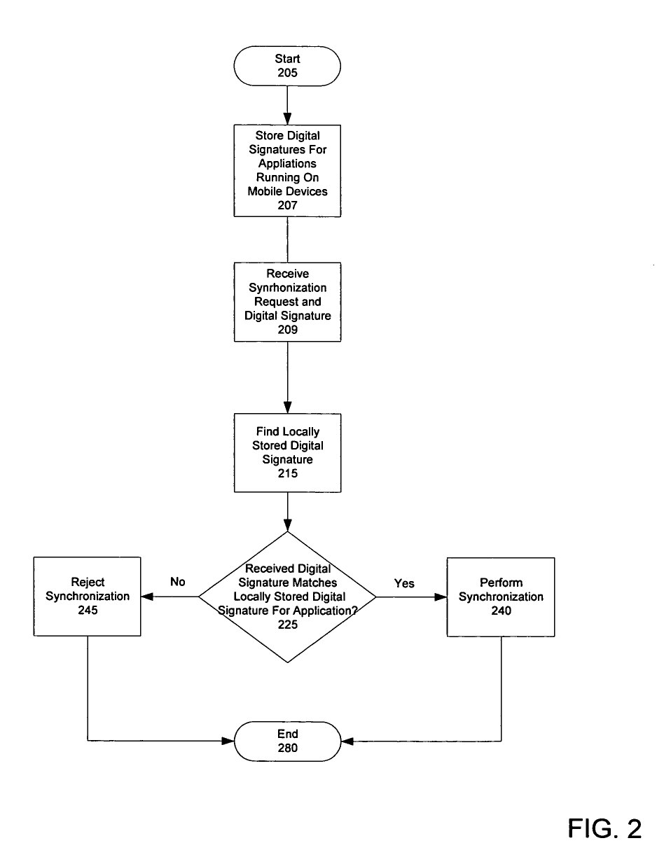

FIG. 2 is a flowchart depicting a secure synchronization process according to one embodiment of the present invention. According to one embodiment, the process shown in FIG. 2 is performed by middleware 105. In the example shown in IG. 2 again the security parameters are digital signatures. The process is initiated in step 205. In step 207, verified digital signatures for applications running on mobile devices are stored locally. These verified digital signatures correspond to application source code that should in fact be deployed to mobile devices. The verified digital signatures are stored in a database in such a way that they can be retrieved as a function of a device identifier and an application identifier. In step 209, a synchronization request and digital signature 150a is received from mobile device 110. The received digital signature 150a corresponds to application code actually residing on the mobile device. In step 210, based upon the mobile device 110 requesting synchronization and the application components 390 running on the mobile device 110, a corresponding digital signature 150b is retrieved from local storage. In step 225, it is determined whether the received digital signature 150a matches the locally stored digital signature 150b. If so (‘yes’branch of step 225), in step 240, a synchronization process 140a is performed with mobile device 110. If not (‘no’branch of step 225), in step 245 the synchronization process is denied 140b . The process ends in step 280.

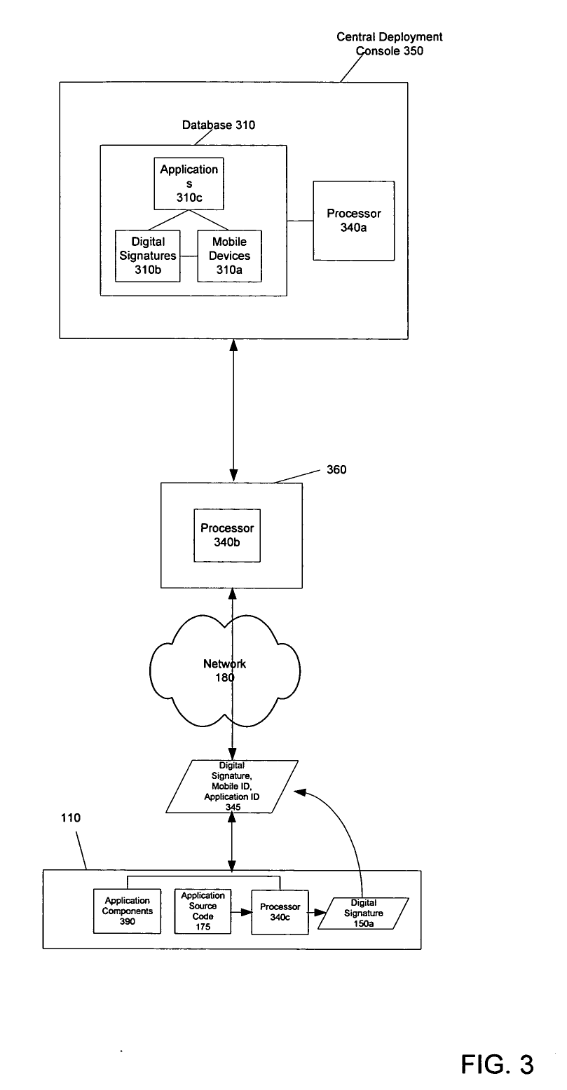

FIG. 3 is a detailed block diagram of a system for performing secure synchronization between a central server and a mobile device according to one embodiment of the present invention. The architecture shown in FIG. 3 represents only one particular exemplary embodiment. Skilled practitioners will understand that any number of alternative architectures may be employed.

Central deployment console 350 includes database 310 and processor 340a. Database 310 may be a relational database and stores tables relating to mobile devices 310a, digital signatures 310b and applications 310c. The information is stored in database 310 in such a fashion that a security parameter (e.g., a digital signature) may be retrieved based upon information regarding a particular mobile device 110 and an application running on that device. FIG. 3 also shows central synchronization point 360, which includes processor 340b.

Mobile device 110 includes processor 340c, application source code 175 and runtime application components 390. Application components 390 correspond to runtime resources for executing a software application. For example, application components 390 may be DLL files, EXE files and/or other resources comprising a running application. Application source code 175 corresponds to the application source code or program code corresponding to application components 390. Before synchronization is requested, processor 340c receives application source code 175 and generates security parameter (e.g., a digital signature) 150a. Digital signature 150a may be generated, for example, using a hash function from application source code 175.

Mobile device 110 desiring to perform synchronization sends a request for synchronization 345 via network 180 to central synchronization point 360. According to one embodiment, request for synchronization 345 includes digital signature 150a, an identifier for mobile device 110 and an identifier for the application components 390 running on mobile device 110. Processor 340b at central synchronization point 360 receives the request for synchronization 345 from mobile device 110 and communicates with central deployment console 350 to perform verification of the digital signature 150a with a digital signature 150b stored in database 310, if one exists. Accordingly, central synchronization point 360 transmits digital signature 150a, the identifier of the mobile device 110 requesting synchronization and the identifier of the application components 390 running on mobile device 110 for which synchronization is requested to central deployment console 350.

Central deployment console 350 fetches the digital signature corresponding to the application and mobile device information from database 310 and compares this locally stored digital signature with that of digital signature 150a received from mobile device 110. If the two digital signatures agree, central deployment console 350 sends a signal to central synchronization point 360 indicating that synchronization should be allowed. If the two digital signatures disagree, central deployment console 350 sends a signal to central synchronization point indicating that synchronization should be denied. Based upon the signal received from central deployment console 350, central synchronization server 360 allows or disallows synchronization with mobile device 375. In one embodiment, if the digital signatures match, central deployment console 350 causes a deployment of software to the mobile device 375.

A method and system for secure synchronization of a mobile device with an enterprise system has been deployed. The method and system operates at the application level by checking the integrity of application source code corresponding to an application running on a mobile device with a verified application source code. Synchronization and deployment are allowed or disallowed based upon this integrity check. In one embodiment, the system may store a plurality of device and/or application identifiers and a security parameter associated with each of the device or application identifiers. Each such security parameter corresponds to a verified code that should be running on a mobile device.

Several embodiments of the invention are specifically illustrated and/or described herein. However, it will be appreciated that modifications and variations of the invention are covered by the above teachings and within the purview of the appended claims without departing from the spirit and intended scope of the invention.

1. A method for synchronizing a device with an enterprise system comprising: storing at least one first security parameter generated as a function of a verified application code at a network node;
receiving an identifier of a device requesting synchronization, an application identifier and at least one second security parameter from the device, the second security parameter generated as a function of code corresponding to an application running on the device;
if the first security parameter matches the second security parameter, performing a synchronization process with the device; and,
if the first security parameter does not match the second security parameter, denying a synchronization process with the device.

2. The method according to claim 1, wherein the first and second security parameters correspond respectively to a first digital signature and a second digital signature.

3. The method according to claim 2, wherein the first and second digital signatures are generated respectively by a hash function from the verified application code and the device application code.

4. The method according to claim 3, wherein the hash function receives a program source code and generates a hash value as a function of the program source code.

5. The method according to claim 1, further including:
if the first security parameter matches the second security parameter, performing a deployment of software to the device;
if the first security parameter does not match the second security parameter, disallowing a deployment of software to the device.

6. The method according to claim 1, wherein the device is a mobile device.

7. The method according to claim 6, wherein the mobile device is a PDA (“Personal Digital Assistant”).

8. A system for synchronizing a device with an enterprise system comprising:
a database, the database storing:
at least one device identifier;
at least one application identifier;
at least one verified security parameter;
wherein each verified security parameter is associated with an application identifier; and,
a processor, the processor configured to:
receive a device identifier, an application identifier and at least one device security parameter from the device, the device security parameter generated as a function of code corresponding to an application running on the device;
determine a corresponding verified security parameter from the database as a function of the application identifier and the device identifier;
if the determined verified security parameter matches the device security parameter, perform a synchronization process with the device; and,
if the determined verified security parameter does not match the device security parameter, deny a synchronization process with the device.

9. The system according to claim 8, wherein the determined verified and the device security parameters correspond respectively to a first digital signature and a second digital signature.

10. The system according to claim 9, wherein the first and second digital signatures are generated by a hash function respectively from a verified code and code corresponding to the application running on the device.

11. The system according to claim 10, wherein the hash function receives a program source code and generates a hash value as a function of the program source code.

12. The system according to claim 8, wherein the processor is further configured to:
if the determined verified security parameter matches the device security parameter, perform a deployment of software to the device; and,
if the determined verified security parameter does not match the device security parameter, disallow a deployment of software to the device.

13. A system for synchronizing a mobile device with an enterprise system comprising:
a central synchronization point, the central synchronization point including a processor;
a central deployment console, the central deployment console including
a processor;
a database, the database storing:
at least one device identifier;
at least one application identifier;
at least one verified security parameter, wherein each verified security parameter corresponds to an application identifier and a device identifier;
wherein the processor at the central synchronization point is configured to:
receive a device security parameter, an application identifier and a device identifier from a device requesting synchronization;
upon receiving the device security parameter, the application identifier and the device identifier, transmit the device security parameter, the application identifier and the device identifier to the central deployment console;
the processor at the central deployment console configured to:
receive a device security parameter, an application identifier and a device identifier from the central synchronization server;
determine a corresponding verified security parameter from the database as a function of the application identifier and the device identifier;
if the corresponding verified security parameter matches the device security parameter, transmit a signal to the central synchronization point indicating synchronization should be allowed; and,
if the corresponding verified security parameter does not match the device security parameter transmit a signal to the central synchronization point indicating synchronization should not be allowed;

14. The system according to claim 13, whereupon the processor at the central synchronization point is configured to upon receiving a signal from the central deployment console indicating that synchronization should be allowed, allow synchronization with the device.

15. The system according to claim 13, whereupon the processor at the central synchronization point is configured to upon receiving a signal from the central deployment console indicating that synchronization should not be allowed, disallow synchronization with the device;

16. A program storage device, the program storage device including instructions for performing synchronization between an enterprise system and a device, the instructions including:
storing at least one verified security parameter generated as a function of a verified application code at a network node;
receiving an identifier of a device requesting synchronization, an application identifier and at least one device security parameter from the device, the device security parameter generated as a function of code corresponding to an application running on the device;
if the verified security parameter matches the device security parameter, performing a synchronization process with the device; and,
if the verified security parameter does not match the device security parameter, denying a synchronization process with the device.
